(19) United States
(12) Patent Application Publication
(10) Pub. No.: US 2016/0034656 A1
(43) Pub. Date: Feb. 4, 2016

(54) PROGRAM FOR VIRTUAL MEDICAL VISITS UTILIZING CELLPHONES

(71) Applicant: BRIAN SADY, Las Vegas, NV (US)

(72) Inventor: BRIAN SADY, Las Vegas, NV (US)

(21) Appl. No.: 14/246,516

(22) Filed: Aug. 4, 2014

(51) Int. Cl. G06F 19/00

(52) U.S. Cl. CPC G06F 19/3418; G06F 19/322; G06F 19/3487

(57) ABSTRACT

A program enabling the doctor to provide the patient with instant diagnosis of medical conditions through the use of sensors within cell phones and other devices during virtual or remote office visits unlike any other programs used solely for referrals to provide the user an instant diagnose of symptoms in real time and to collect data for immediate treatment options, billing, prescribing, retrieving, transferring, and storing patient medical records in an encrypted file for HIPPA compliance through the use of video, audio, and sensors available through cell phones

Combining the use of sensors in cell phones and other technology allows for virtual online physician and patient consultation with instantaneous results.

A program designed to provide virtual medical visits utilizing cell phones and the technologies within the cell phones including, but not limited to, video conferencing to be used during visits as a diagnostic point to instantly examine and determine results of vital signs, blood tests, urine tests, rapid tests such as Strep and H Pylori tests, EKG testing, pulse oximetry, pregnancy tests and more, and the monitoring of emotional conditions of patients. The program allows the use of cell phones with speech translation capability during these virtual medical visits including, but not limited to, Google Translate and/or AT & T conference translators, use of medical recognition capability utilizing the cell phone camera to aid in the diagnosis of dermatologic rashes and more. The program allows for instant billing, prescribing, capturing, transferring, and storing patient medical information with encrypted file storage for HIPPA compliance. Wifi, VOIP, and others can be used for communication and file transfers required for remote medical visits and the medical provider, patients, or both may utilize these capabilities during virtual visits in real time.

### APPLICATION

The Program utilized the existing technologies in real time during the medical visit between the doctor and the patient. Existing and developing chip processing speeds and power, cellular technologies, data limits and speeds on cellular satellite and WIFI networks, security software and hardware, will aid and improve the use of cell phones as a means of enhancing the virtual medical visit experience. Cell phone software will be able to utilize all of the described functions creating a fluid virtual medical visit via the cell phone. Existing virtual visits are extremely limited and do not permit the required processes to take place instantly during the visit as will be available in this described program.

### OVERVIEW

The program combines an assortment of available technologies creating online consulting between physician and patient with instantaneous results transmitted electronically over the web via a secure connection to a physician for further interpretation of data. Existing programs do not have available data as is offered by this program to aid in instantaneous and accurate physical and emotional diagnoses.

Cell Phone cameras are used to instantly diagnose conditions of the skin, inner eye and other areas of concern of doctors.

1. An otherwise unavailable program that interprets user inputted dated thereby providing instantaneous and accurate physical and emotional diagnoses of medical conditions and remedies in real time and collects data for immediate treatment options, billing, prescribing, retrieving transferring, and storing patient medical records in an encrypted file for HIPPA compliance.
